(19) United States
(12) Patent Application Publication
(10) Pub. No.: US 2020/0383442 A1
(43) Pub. Date: Dec. 10, 2020

(54) Protective Case

(71) Applicant: Rohan Vishnubhai Patel, Bensalem, PA (US)

(72) Inventor: Rohan Vishnubhai Patel, Bensalem, PA (US)

(21) Appl. No.: 16/432,970

(22) Filed: Jun. 6, 2019

(51) Int. Cl. A45C 13/00; G06F 1/16

(52) U.S. Cl. CPC A45C 13/002; A45C 2011/002; G06F 1/1626

(57) ABSTRACT

A protective case for an electronic device is provided. The protective case is made of non-stretchable material. The edges of the protective case have one or more slits in the corner regions. These one or more slits provide flexibility enough to insert an electronic device in the protective case, while providing protection to the electronic device in an event of an accidental fall.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a protective case. More so, the present invention relates to a protective casemade of a non-flexible or a semi-rigid material.

### Description of the Related Art

With a small slit at or near corners a case made out from rigid (non stretchable) material can be installed easily on a mobile/tablet device. This protective case also can be used to protect a wrist watch, license plate of a vehicle, a screen or any kind of electronic device.

Presently this issue is resolve by removal of large portion of side walls to allow the non rigid material to flex enough so a mobile product can be inserted in it. By having a small slits near walls can allow similar flexibility with additional protection around the edge of the device and protection of top border of a screen or mobile device.

Various types of protective cases available in the market that help secure edges of a mobile phone and a tablet. This prevents damage to an electronic device such as a mobile phone and a tablet from accidental fall.

Typically such cases are made of hard materials or soft flexible materials. It is easy to insert an electronic device in a soft protective case; however, such soft protective cases provide low grade protection to the secured electronic device. While protective cases made of hard material provide better protection it is difficult to insert an electronic device in it. In an alternative version, a large portion of side walls is removed from hard protective case that allows flexibility, which in turn allows insertion of an electronic device in a hard protective case. This removal of significant portion of side wall compromises the safety of the secured electronic device, in case of an accidental fall.

In light of the above mentioned drawbacks, there exists a need of a protective case that allows ease of insertion of an electronic device while providing high grade protection to the edges of the electronic device.

### BRIEF SUMMARY OF THE INVENTION

A primary object of the disclosure is to provide a protective case for an electronic device made of rigid material.

Another object of the present disclosure is to provide a protective case for an electronic device that allows easy insertion of the electronic device in the protective case.

### DESCRIPTION OF THE DRAWINGS

Having thus described the disclosure in general terms, reference will now be made to the accompanying figure, wherein:

FIG. 1 illustrates a protective case, in accordance with an embodiment of the present disclosure; and

FIG. 2 illustrates a corner region of a protective case, in accordance with an embodiment of the present disclosure.

FIG. 3 illustrates a cross section of the protective case shown in FIG. 1 in accordance with an embodiment of the present disclosure.

It should be noted that the accompanying figure are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figure is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

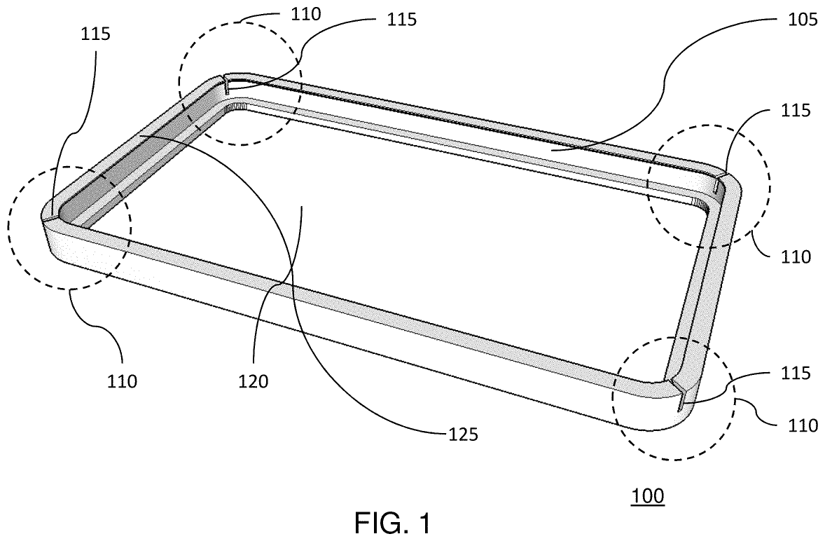

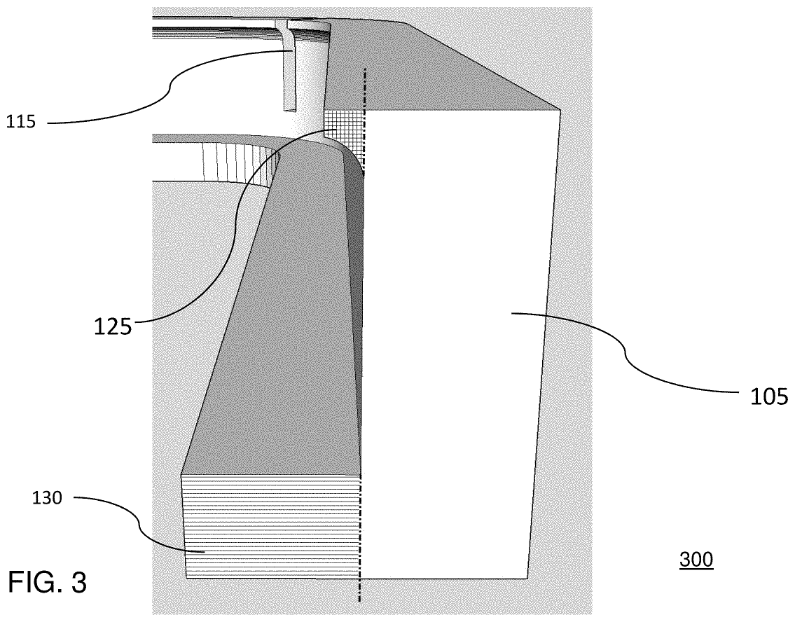

FIG. 1 illustrates a protective case 100, in accordance with an embodiment of the present disclosure. The protective case 100 has an edge surface 105. The edge surface 105 is designed to stay flushed with four sides of an electronic device and provides protection to the sides of the electronic device. The electronic device can be a mobile phone, tablet, and so forth. The electronic device is not shown in the FIG. 1 for the sake of clarity. The edge surface 105 of the protective case 100 is made of a semi-rigid or a non-flexible material. A semi-rigid or non-flexible can be aluminium like metal, plastic, wood, a carbon fiber, or a similar non-flexible material. The edge surface 105 secures an electronic device. The edge surface 105 has a plurality of corner regions 110. Each of the plurality of corner regions 110 has one or more slits 115. The one or more slits 115 enable insertion of an electronic device in the protective case 100. In an embodiment of the present disclosure, the one or more slits 115 is a full slit, reaching substantially near a back surface 120 of the protective case 100. The back surface 120 can be made of a semi rigid or a non-flexible material. Also the back surface 120 can be of a substantially square shape or a substantially rectangular shape. In another embodiment of the present disclosure, the one or more slits 115 is a partial slit. It will be understood to a person ordinarily skilled in the art that the one or more slits 115 can be one slit, as shown in FIG. 3, or the one or more slits 115 can be two slit, as shown in FIG. 4. In accordance with various embodiments of the disclosure, there could be any number of slits in the corner region 110. In an embodiment of the present disclosure, the protective case 100 has a lip 125, not shown in FIG. 1. The lip 125 secures an electronic device to the protective case 100. It should be noted that the lip 125 can be of several shapes/sizes and can be placed at different locations on the protective case 100. As shown in FIG. 1 the edge wall can provide protection to the entire side of the electronic device. Also a slit can be wide enough to serve a dual purpose of providing enough flexibility so the case can be inserted over an electronic device and provide functionality to operate the electronic device. Also as shown in FIG. 1 & FIG. 3 the edge surface can be as tall to provide protection to entire side section's height from bottom to the top.

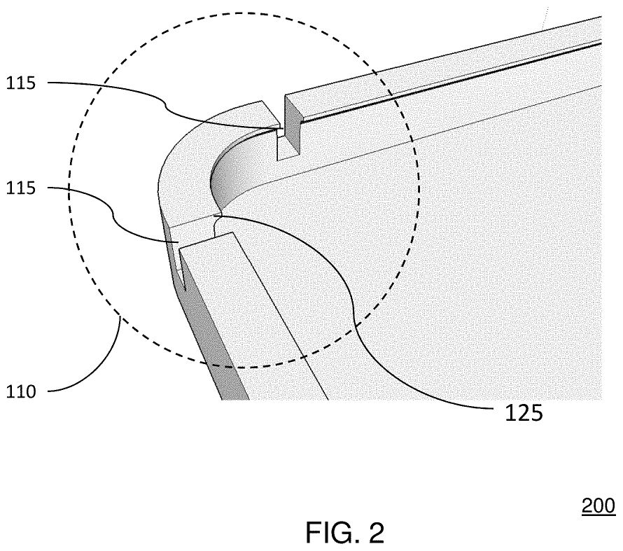

FIG. 2 illustrates the corner region 110 of the protective case 200, in accordance with an embodiment of the present disclosure. The corner region 110 is shown to include two slits 105, one on either side of the corner. It will be apparent to a person ordinarily skilled in the art that various shapes, sizes and arrangements of slits are possible in the corner region 110, without affecting the scope of the present disclosure.

FIG. 3 illustrates a cross section of the protective case shown in FIG. 1. The cross section shows 3 separate regions for sake of clarity. The edge region 105, shown as a vertical edge, protects the sides of the electronic device. The base 130 is attached to the edge region 105 and is marked with horizontal lines in FIG. 3. The base region's functionality is to connect all edge regions together. The base region also acts as a stopper in order to secure the inserted (not shown) electronic device from slipping out from the bottom side of the protective case. The grid region 125 is connected to the edge region 105 and is marked with a grid lines in FIG. 3. The lip region 125 secures the electronic device between the lip 125 and the base 130. Additionally the slit 115 is a separation that goes through both the lip 125 and the edge region 105 to allow flexibility to insert an electronic device into the protective case. The edge 105, lip 125 and base 130 are all made from non-stretchable material.

Present disclosure provides several advantages over existing art. The protective case 100 or 200 is made of rigid material that provides proper protection to an electronic device. Also, the protective case 100 or 200 allows easy insertion of an electronic device in the protective case.

What is claimed is:

1. A protective case for an electronic device, wherein the protective case consists of:
a base surface;
an edge surface; wherein the edge surface is directly connected to the base surface; wherein the base surface and the edge surface are configured to provide protection to at least four sides of the electronic device; wherein the edge surface is continuous; wherein the edge surface is configured to have at least one protruding lip; wherein the at least one protruding lip secures the electronic device from slipping out of the protective case; wherein the at least one protruding lip is made of non-stretchable material; wherein at least one slit goes through both the edge surface and the at least one protruding lip; whereby the at least one slit enables insertion of the electronic device in the protective case.

2. The protective case as claimed in claim 1, wherein at least one full slit.

3. The protective case as claimed in claim 1, wherein at least one partial slit.

4. The protective case as claimed in claim 1, wherein the case is made out of a carbonfiber material.

5. The protective case as claimed in claim 1, wherein the case is made out of a metal like material.

6. The protective case as claimed in claim 1, wherein at least one slit is located to provide access to control the electronic device wherein the slip serves dual purpose of providing flexibility to insert the electronic device within and provide access to control the electronic device.

7. The protective case as claimed in claim 1, wherein the case is made out of a wooden material.

8. The protective case as claimed in claim 1, wherein at least one slit is located at or near the corner region of the case.

9. A protective case for an electronic device, the protective case consists of:
a back surface, wherein the back surface protects at least one side of the electronic device; and
an edge surface; wherein the edge surface is directly connected to the back surface; wherein the back surface and the edge surface are configured to protect at least four sides of the electronic device; wherein the edge surface is attached to the back surface; wherein the edge surface of the protective case is made of non-stretchable material; wherein the edge surface is continuous; wherein the edge surface is configured to have at least one protruding lip, wherein the at least one protruding lip secures the electronic device from slipping out of the protective case; wherein the at least one protruding lip is made of a non-stretchable material; wherein at least one slit goes through both the edge surface and the at least one protruding lip; whereby the at least one slit enables insertion of the electronic device into the protective case.

10. The protective case as claimed in claim 9, wherein at least one slit is a full slit.

11. The protective case as claimed in claim 9, wherein at least one slit is a partial slit.

12. The protective case as claimed in claim 9, wherein the case is made out of a carbon fiber material.

13. The protective case as claimed in claim 9, wherein the case is made out of a metal like material.

14. The protective case as claimed in claim 1, wherein at least one slit is located to provide access to control the electronic device wherein the slip serves dual purpose of providing flexibility to insert the electronic device within and provide access to control the electronic device.

15. The protective case as claimed in claim 9, wherein the case is made out of a wooden material.

16. A protective case wherein the protective case consists of:
a base surface;
an edge surface; wherein the edge surface is directly connected to the base surface and the edge surface is designed to protect at least four sides of a product its being used with; wherein the protective case provides protection to the product; wherein the edge surface has at least one protruding lip to stop inserted product from slipping out of the protective case wherein the edge surface of the protective case is made of non-stretchable material, wherein the at least one protruding lip secures the product from slipping out of the protective case; wherein the at least one protruding lip is made of non-stretchable material; wherein at least one slit goes through both the edge surface and the at least one protruding lip; whereby the at least one slit enables insertion of the product in the protective case.

17. The protective case as claimed in claim 16, wherein at least one slit is located at or near the corner region.

18. The protective case as claimed in claim 16, wherein the protective case is being used as a license plate frame on an automobile.

19. The protective case as claimed in claim 16, wherein the protective case is being used for a screen.

20. The protective case as claimed in claim 16, wherein the protective case is being used for a wrist watch.
